(19) United States
(12) Patent Application Publication
(10) Pub. No.: US 2019/0310817 A1
(43) Pub. Date: Oct. 10, 2019

(54) DISPLAY PANEL, MANUFACTURING METHOD THEREOF, DISPLAY DEVICE AND SMART GLASSES

(71) Applicant: BOE TECHNOLOGY GROUP CO., LTD., Beijing (CN)

(72) Inventors: Xitong MA, Beijing (CN); Naifu WU, Beijing (CN)

(21) Appl. No.: 16/295,067

(22) Filed: Mar. 7, 2019

(30) Foreign Application Priority Data
Apr. 9, 2018 (CN) 201810309497.3

(51) Int. Cl. G06F 3/147

(52) U.S. Cl. CPC G06F 3/147

(57) ABSTRACT

Disclosed is a display panel, a method for manufacturing the same, a display device, and smart glasses. The display panel includes: a substrate and a pixel array disposed on the substrate. A contour shape of the pixel array is same to a contour shape of the display panel; the contour shape of the display panel is one of a pillow contour shape and a barrel contour shape. For the pillow contour shape, an area of the pixel in the pixel array increases as the distance between the pixel and the central axis of the pixel array increases; for the barrel contour shape, an area of the pixel in the pixel array decreases as the distance between the pixel and the central axis of the pixel array increases.

### RELATED APPLICATIONS

The present application claims the benefit of Chinese Patent Application No. 201810309497.3, filed on Apr. 9, 2018, the entire disclosures of which are incorporated herein by reference.

### TECHNICAL FIELD

The present disclosure relates to the field of virtual reality technologies, and in particular, to a display panel, a method for manufacturing the same, a display device, and smart glasses.

### BACKGROUND

When displaying an image, an augmented reality (AR) device or a virtual reality (VR) device may cause image distortion of the displayed image due to a lens or an optical component disposed therein. In the related art, in order to reduce image distortion, the image is subjected to distortion correction while optimizing the optical components. Distortion correction of an image is generally performed by stretching the image adversely, allowing the image to be displayed properly. However, this will result in a loss of physical resolution of the image.

### SUMMARY

In an exemplary embodiment, a display panel is provided. The display panel includes: a substrate and a pixel array disposed on the substrate. A contour shape of the pixel array is same to a contour shape of the display panel; the contour shape of the display panel is one of a pillow contour shape and a barrel contour shape; the pillow contour shape is recessed from a periphery toward a center, and the barrel contour shape is convex from a center to a periphery. Distortion of a pixel in the pixel array increases as a distance between the pixel and a central axis of the pixel array increases. For the pillow contour shape, an area of the pixel in the pixel array increases as the distance between the pixel and the central axis of the pixel array increases; for the barrel contour shape, an area of the pixel in the pixel array decreases as the distance between the pixel and the central axis of the pixel array increases.

In some exemplary embodiments, the pixel array is composed of N pixel blocks; N is a natural number greater than 1; pixel numbers of the N pixel blocks are equal; the contour shape of the pixel array is formed by a contour shape of the N pixel blocks; a contour shape of each pixel block is substantially same to a contour shape of a pixel in the pixel block. Distortion of a pixel block increases as a distance between the pixel block and the central axis of the pixel array increases. For the pillow contour shape, an area of the pixel block increases as the distance between the pixel block and the central axis of the pixel array increases; for the barrel contour shape, an area of the pixel block decreases as the distance between the pixel block and the central axis of the pixel array increases.

In some exemplary embodiments, pixels in the pixel array are non-uniformly distributed.

In some exemplary embodiments, for the pillow contour shape, a density of the pixels in the pixel array gradually decreases in a direction away from the central axis; for the barrel shape, a density of the pixels in the pixel array gradually increases in a direction away from the central axis.

In another exemplary embodiment, a display device is provided. The display device includes the display panel according to any one of the above-mentioned exemplary embodiments and an optical component. The display panel is located on an object plane of the optical component, and the optical component has an imaging distortion complementary to the contour shape of the display panel.

In yet another exemplary embodiment, a pair of smart glasses is provided. The pair of smart glasses includes the display panel according to any one of the above-mentioned embodiments and an optical component. The display panel is located on an object plane of the optical component, and the optical component has an imaging distortion complementary to the contour shape of the display panel.

In still another exemplary embodiment, a method for manufacturing a display panel is provided. The method includes: providing a substrate; and forming a pixel array on the substrate. A contour shape of the pixel array is same to a contour shape of the display panel; the contour shape of the display panel is one of a pillow contour shape and a barrel contour shape; the pillow contour shape is recessed from a periphery toward a center, and the barrel contour shape is convex from a center to a periphery. Distortion of a pixel in the pixel array increases as a distance between the pixel and a central axis of the pixel array increases. For the pillow contour shape, an area of the pixel in the pixel array increases as the distance between the pixel and the central axis of the pixel array increases; for the barrel contour shape, an area of the pixel in the pixel array decreases as the distance between the pixel and the central axis of the pixel array increases.

In some exemplary embodiments, the pixel array is composed of N pixel blocks; N is a natural number greater than 1; pixel numbers of the N pixel blocks are equal; the contour shape of the pixel array is formed by a contour shape of the N pixel blocks; a contour shape of each pixel block is substantially same to a contour shape of a pixel in the pixel block. Distortion of a pixel block increases as a distance between the pixel block and the central axis of the pixel array increases. For the pillow contour shape, an area of the pixel block increases as the distance between the pixel block and the central axis of the pixel array increases; for the barrel contour shape, an area of the pixel block decreases as the distance between the pixel block and the central axis of the pixel array increases.

In some exemplary embodiments, pixels in the pixel array are non-uniformly distributed.

In some exemplary embodiments, for the pillow contour shape, a density of the pixels in the pixel array gradually decreases in a direction away from the central axis; for the barrel shape, a density of the pixels in the pixel array gradually increases in a direction away from the central axis.

In some exemplary embodiments, the step of forming the pixel array on the substrate includes: forming the pixel array based on an array of distorted grids. A contour shape of the array of distorted grids is same to the contour shape of the display panel; the contour shape of the display panel is one of a pillow contour shape and a barrel contour shape; the pillow contour shape is recessed from a periphery toward a center, and the barrel contour shape is convex from a center to a periphery. Distortion of a distorted grid in the array of distorted grids increases as a distance between the distorted grid and a central axis of the array of distorted grids increases. For the pillow contour shape, an area of the distorted grid in the array of distorted grids increases as the distance between the distorted grid and the central axis of the array of distorted grids increases; for the barrel contour shape, an area of the distorted grid in the array of distorted grids decreases as the distance between the distorted grid and the central axis of the array of distorted grids increases.

In some exemplary embodiments, before the step of forming the pixel array based on an array of distorted grids, the method further includes: performing a distortion process to an array of rectangular grids based on an optical parameter to obtain the array of distorted grids.

In some exemplary embodiments, the step of performing a distortion process to an array of rectangular grids based on an optical parameter to obtain the array of distorted grids includes: obtaining a model of an optical component having an imaging distortion; inputting the array of rectangular grids into an image plane of the optical component; and performing optical tracking to the array of rectangular grids to obtain the array of distorted grids on the object plane of the optical component.

### BRIEF DESCRIPTION OF THE DRAWINGS

In order to more clearly illustrate the technical solutions in embodiments of the disclosure or in the prior art, the appended drawings needed to be used in the description of the exemplary embodiments or the prior art will be introduced briefly in the following. Obviously, the drawings in the following description are only some embodiments of the disclosure, and for those of ordinary skills in the art, other drawings may be obtained according to these drawings under the premise of not paying out creative work.

FIG. 1 is a schematic diagram of an image of rectangular grids according to the related art;

FIG. 2 is a schematic diagram of an image of rectangular grids with pillow distortion according to the related art;

FIG. 3 is a schematic diagram of an image of rectangular grids according to the related art, in which distortion correction is performed on the image shown in FIG. 2;

FIG. 4 is a schematic diagram of an image of rectangular grids with keystone distortion according to the related art;

FIG. 5 is a schematic diagram of another image of rectangular grids with keystone distortion according to the related art;

FIG. 6 is a schematic diagram of an image of rectangular grids according to the related art, in which distortion correction is performed on the image shown in FIG. 4 or FIG. 5;

FIG. 7 is a schematic diagram showing a relationship between a pixel distribution and a display area of a display panel according to the related art;

FIG. 8A is a structural schematic diagram of a display panel according to an embodiment of the present disclosure;

FIG. 8B is a structural schematic diagram of a display panel according to another embodiment of the present disclosure;

FIG. 8C is a structural schematic diagram of a pair of smart glasses according to an embodiment of the present disclosure;

FIG. 9 is a structural schematic diagram of a pixel according to the related art; and

FIG. 10 is a flow chart of a method for manufacturing a display panel according to an embodiment of the present disclosure.

### DETAILED DESCRIPTION OF THE DISCLOSURE

In the following, the technical solutions in exemplary embodiments of the disclosure will be described clearly and completely in connection with the drawings in the embodiments of the disclosure. Obviously, the described exemplary embodiments are only part of the embodiments of the disclosure, and not all of the embodiments. Based on the embodiments in the disclosure, all other embodiments obtained by those of ordinary skills in the art under the premise of not paying out creative work pertain to the protection scope of the disclosure.

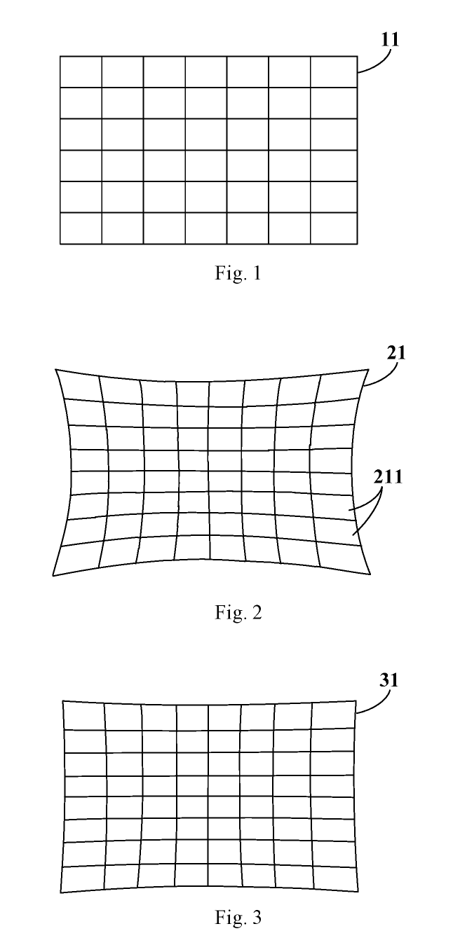

In the related art, optical components (for example, lenses or lens groups) are disposed in smart glasses (VR glasses, AR glasses). Due to the nature of the optical components themselves, the image displayed on the display screen in the smart glasses is distorted after passing through the optical components (or optical imaging system). In order to reduce the distortion of the image, distortion correction may be performed on the image to be displayed on the display screen in advance. For example, as shown in FIGS. 1-3, if the image displayed on the display screen has barrel distortion after passing through the optical components (or optical imaging system), in order to reduce the distortion degree of the image, pillow distortion may be performed to the image of normal (i.e. rectangular) grids shown in FIG. 1. As a result, an image 21 as shown in FIG. 2 can thus be obtained. The image 21 shown in FIG. 2 is then input to the display screen for display. In this way, the image 21 displayed on the display screen undergoes barrel distortion after passing through the optical components (or optical imaging system), and an image 31 as shown in FIG. 3 can be obtained. As can be seen from FIG. 3, the distortion degree of the image 31 is reduced.

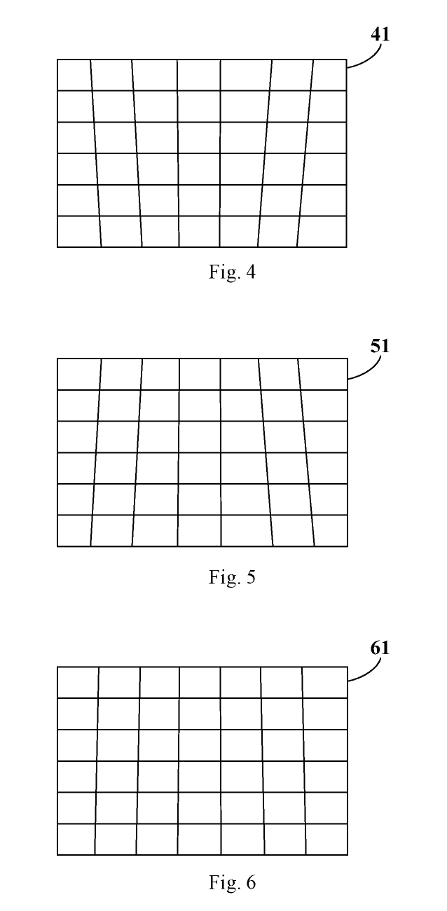

In another exemplary embodiment, as shown in FIGS. 1 and 4-6, if the image 11 displayed on the display screen has keystone distortion after passing through the optical components (or optical imaging system), resulting in an image of keystone distortion 41, in order to reduce the distortion degree of the image, reverse keystone distortion may be performed to the image of normal (i.e. rectangular) grids shown in FIG. 1, an image 51 as shown in FIG. 5 can thus be obtained. The image 51 shown in FIG. 5 is then input to the display screen for display. In this way, the image 51 having keystone distortion displayed on the display screen undergoes keystone distortion after passing through the optical components (or optical imaging system), and an image 61 as shown in FIG. 6 can be obtained. As can be seen from FIG. 6, the distortion degree of the image 31 is reduced.

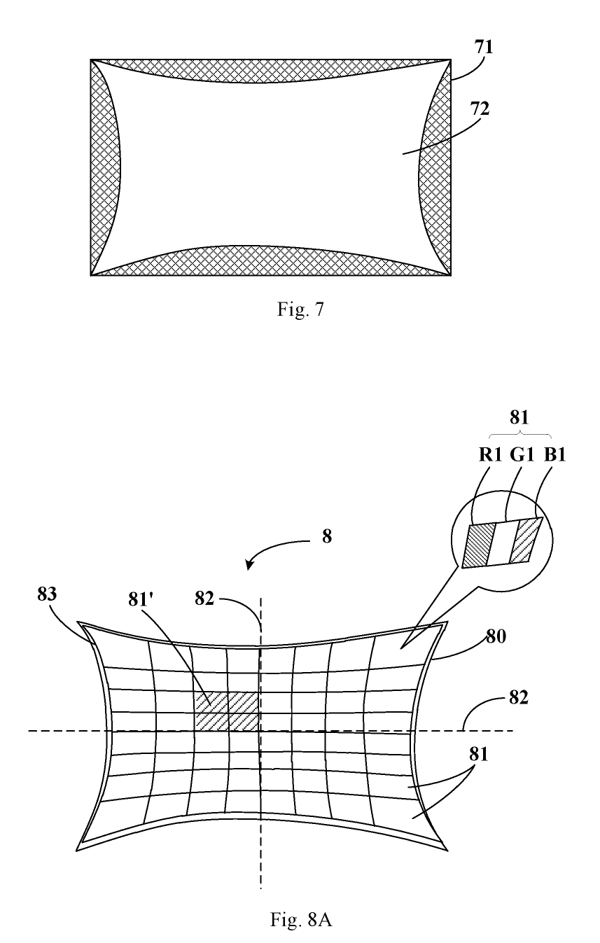

The pixels of the display screen can be arranged according to the distortion mesh curve in the image of grids undergoing distortion correction, so that the distribution of the pixels conforms to the rule of the distortion mesh, then the image can be restored when imaged by the optical components (or optical imaging system). Although distortion correction can be achieved in this way, there is still a loss in physical pixel resolution. For example, as shown in FIG. 7, for a display panel having a certain resolution, in order to achieve image distortion correction, it is necessary to compress the image of distortion correction into the display area 72. However, the display area 72 is smaller than the entire display area 71 of the display panel. Thus, compared to the entire display area 71 of the display panel, the physical pixels actually used for display are reduced. Therefore, regardless of whether or not the optical component (optical imaging system) is applied, the image cannot have the original physical resolution of the display panel, resulting in a degradation of the image quality.

Therefore, the present disclosure provides a display panel, a method of manufacturing the same, a display device, and smart glasses, which can avoid loss of physical pixel resolution caused by image distortion correction.

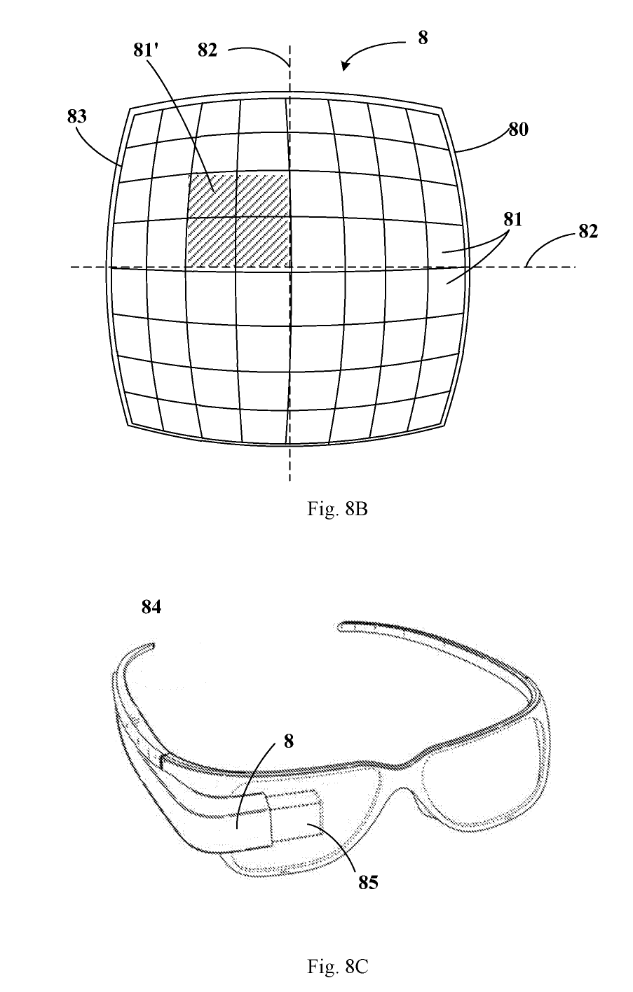

FIGS. 8A-8B show display panels 8 according to an exemplary embodiment, which is applicable to display devices of smart glasses. The smart glasses may also include an optical component for cooperating with the display device. The display panel is located on an object plane of the optical component, the optical component having an imaging distortion that is complementary to a contour shape of the display panel. When the smart glasses are worn by the user, the image displayed by the display device can be observed by the user after passing through the optical component.

As shown in FIGS. 8A-8B, the contour shape of the display panel 8 is a pillow contour shape or a barrel contour shape. As shown in FIG. 8A and FIG. 8B, the display panel 8 includes: a substrate 80 and a pixel array disposed on the substrate 80. A contour shape 83 of the pixel array is same to a contour shape of the display panel; the contour shape 83 of the display panel is one of a pillow contour shape (shown in FIG. 8A) and a barrel contour shape (shown in FIG. 8B); the pillow contour shape is recessed from a periphery toward a center, and the barrel contour shape is convex from a center to a periphery. Distortion of a pixel 81 in the pixel array increases as a distance between the pixel 81 and a central axis 82 of the pixel array increases. For the pillow contour shape, an area of the pixel 81 in the pixel array increases as the distance between the pixel 81 and the central axis 82 of the pixel array increases; for the barrel contour shape, an area of the pixel 81 in the pixel array decreases as the distance between the pixel 81 and the central axis 82 of the pixel array increases.

When the display panel 8 described above is applied to a display device such as the smart glasses 84 as shown in FIG. 8C, if the contour shape of the display panel 8 is a pillow contour shape, the image displayed by the display panel 8 has a barrel distortion after passing through the optical component 85 in the smart glasses 84; if the contour shape of the display panel 8 is a barrel contour shape, the image displayed by the display panel 8 has a pillow distortion after passing through the optical component 85 in the smart glasses 84. That is, the optical component 85 has an imaging distortion that is complementary to the contour shape of the display panel 8.

In the exemplary embodiments of the present disclosure, the contour shape of the display panel is a pillow contour shape or a barrel contour shape, and the contour shape of the pixel array is the same as the contour shape of the display panel. If the contour shape of the display panel is a pillow contour shape, the area of the pixel in the pixel array gradually increases in a direction departing from the central axis of the pixel array; if the contour shape of the display panel is a barrel contour shape, the area of the pixel in the pixel array gradually decreases in a direction departing from the central axis of the pixel array. When the image to be displayed is displayed by the display panel, the display panel performs a first distortion process to the image to be displayed, thereby obtaining a first distorted image. When the display panel is applied to a display device such as a pair of smart glasses, after the first distorted image passes through the optical component in the smart glasses, the optical component performs a second distortion process to the first distorted image, thereby obtaining a second distorted image. The distortion direction of the first distortion process is opposite to the distortion direction of the second distortion process, and the distortion degree of the second distorted image is smaller than the distortion degree of the first distorted image. By applying the above-mentioned display panel to the smart glasses, the image distortion caused by the optical component in the smart glasses can be reduced. Moreover, since all the pixels on the display panel are used to display the image to be displayed, the loss of physical pixel resolution due to image distortion correction can be avoided.

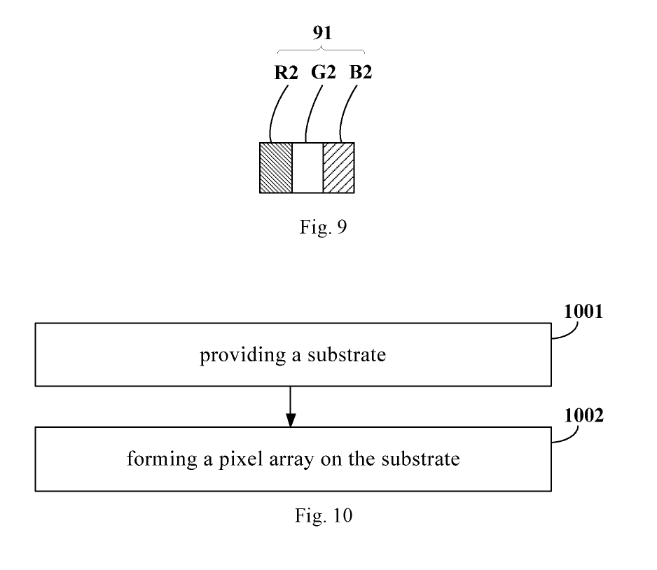

In an exemplary embodiment, as shown in FIG. 8A, each pixel 81 includes a sub-pixel R1 (red sub-pixel), G1 (green sub-pixel), and B1 (blue sub-pixel). The contour shapes of the sub-pixels R1, G1, and B1 are the same as the contour shape of the associated pixel 81. That is to say, the sides of the sub-pixels R1, G1, and B1 are in correspondence with the inclination of the four sides of the associated pixel 81. In the related art, the contour shape of the pixel 91 shown in FIG. 9 is rectangular, and the contour shapes of the sub-pixel R2 (red sub-pixel), G2 (green sub-pixel), and B2 (blue sub-pixel) included in the pixel 91 are also rectangular.

In an exemplary embodiment, the pixel array is composed of N pixel blocks 81′; N is a natural number greater than 1; pixel numbers of the N pixel blocks 81′ are equal; the contour shape of the pixel array is formed by a contour shape of the N pixel blocks; a contour shape 83 of each pixel block 81′ is substantially same to a contour shape of a pixel 81 in the pixel block 81′. Distortion of a pixel block 81′ increases as a distance between the pixel block 81′ and the central axis 82 of the pixel array increases. For the pillow contour shape, an area of the pixel block 81′ increases as the distance between the pixel block 81′ and the central axis 82 of the pixel array increases; for the barrel contour shape, an area of the pixel block 81′ decreases as the distance between the pixel block 81′ and the central axis 82 of the pixel array increases. In other words, the variation tendency of the pixel 81 and the variation tendency of the pixel block 81′ are the same. In general, each of the pixel blocks 81′ includes a plurality of pixels 81, and the contour shapes of the pixels 81 in a pixel block 81′ are the same as the contour shape of the pixel block 81′. Moreover, the areas of all the pixels 81 in one pixel block 81′ may be the same.

In an exemplary embodiment, pixels in the pixel array are non-uniformly distributed. For the pillow contour shape, a density of the pixels in the pixel array gradually decreases in a direction away from the central axis; for the barrel shape, a density of the pixels in the pixel array gradually increases in a direction away from the central axis.

An exemplary embodiment of the present disclosure also provides a display device such as a pair of smart glasses. As shown in FIG. 8C, the pair of smart glasses 84 includes the display panel 8 described above and an optical component 85. The display panel 8 is located on an object plane of the optical component 85, and the optical component 85 has an imaging distortion complementary to the contour shape of the display panel 8. After imaging by the optical component 85, the display panel 8 exhibits a contour shape with a small distortion degree compared with a rectangle.

When the contour shape of the display panel 8 is a pillow contour shape, the image displayed by the display panel 8 has a barrel distortion after passing through the optical component in the smart glasses; when the contour shape of the display panel 8 is a barrel contour shape, the image displayed by the display panel 8 has a pillow distortion after passing through the optical component in the smart glasses. In this way, after imaging by the optical component 85, the display panel 8 exhibits a contour shape with a small distortion degree compared with a rectangle, therefore, the image distortion caused by the optical component in the smart glasses can be reduced. Moreover, since all the pixels on the display panel are used to display the image to be displayed, the loss of physical pixel resolution due to image distortion correction can be avoided.

Those skilled in the art can understand that the display panel can also be disposed in a display device such as a virtual reality helmet, and the present disclosure is not limited thereto.

An exemplary embodiment of the present disclosure also provides a method for manufacturing the display panel described above. Referring to FIG. 10, the method includes the following steps 1001-1002: step 1001, providing a substrate; and step 1002, forming a pixel array on the substrate. As shown in FIG. 8A and FIG. 8B, the display panel 8 includes: a substrate 80 and a pixel array disposed on the substrate 80. A contour shape 83 of the pixel array is same to a contour shape of the display panel; the contour shape 83 of the display panel is one of a pillow contour shape (shown in FIG. 8A) and a barrel contour shape (shown in FIG. 8B); the pillow contour shape is recessed from a periphery toward a center, and the barrel contour shape is convex from a center to a periphery. Distortion of a pixel 81 in the pixel array increases as a distance between the pixel 81 and a central axis 82 of the pixel array increases. For the pillow contour shape, an area of the pixel 81 in the pixel array increases as the distance between the pixel 81 and the central axis 82 of the pixel array increases; for the barrel contour shape, an area of the pixel 81 in the pixel array decreases as the distance between the pixel 81 and the central axis 82 of the pixel array increases.

In an exemplary embodiment, the step 1002 may include the following sub-step 1002′: forming the pixel array based on an array of distorted grids. A contour shape of the array of distorted grids is same to the contour shape of the display panel; the contour shape of the display panel is one of a pillow contour shape and a barrel contour shape; the pillow contour shape is recessed from a periphery toward a center, and the barrel contour shape is convex from a center to a periphery. Distortion of a distorted grid in the array of distorted grids increases as a distance between the distorted grid and a central axis of the array of distorted grids increases. For the pillow contour shape, an area of the distorted grid in the array of distorted grids increases as the distance between the distorted grid and the central axis of the array of distorted grids increases; for the barrel contour shape, an area of the distorted grid in the array of distorted grids decreases as the distance between the distorted grid and the central axis of the array of distorted grids increases. The array of distorted grids in this embodiment may have a pattern of the image 21 as shown in FIG. 2, and the array of distorted grids is composed of a plurality of distorted grids 211.

The following is an example in which the contour shape of the array of distorted grids is a pillow contour shape. As shown in FIG. 2, the contour shape of the display panel 8 is determined according to the contour shape of the array of distorted grids. Then, the display panel 8 is divided into an array of pixel blocks composed of N pixel blocks according to the distorted grids 211 in the array of distorted grids. The contour shapes of the N pixel blocks are in one-to-one correspondence with the contour shapes of the N distorted grids 211. The corresponding pixels 81 are manufactured in each of the N pixel blocks. In an exemplary embodiment, the number of pixels 81 corresponding to each of the pixel blocks is equal to the ratio of the total number of pixels in the display panel to the number N of pixel blocks. That is, the pixels 81 are equally distributed for all the pixel blocks according to the number of pixels of the image to be displayed and the number of pixel blocks. For example, if the number of pixels of an image to be displayed is 1920×1080, and the number of pixel blocks is 480×270, sixteen pixels 81 are included in each pixel block.

In an exemplary embodiment of the present disclosure, the coordinates of the pixel blocks may be determined according to the coordinates of the corresponding distorted grids 211 in the array of distorted grids. The coordinates of the pixels 81 may be determined according to the coordinates of the corresponding pixel blocks. Then, the pixels 81 may be manufactured according to the coordinates of the pixels 81.

In an exemplary embodiment, before the sub-step 1002′, the step 1002 may further include a sub-step 1002″: performing a distortion process to an array of rectangular grids based on an optical parameter to obtain the array of distorted grids.

In an exemplary embodiment, the sub-step 1002″ may specifically include: (1) obtaining a model of an optical component having an imaging distortion; (2) inputting the array of rectangular grids into an image plane of the optical component; and (3) performing optical tracking to the array of rectangular grids to obtain the array of distorted grids on the object plane of the optical component.

In an exemplary embodiment, the model of the optical component described above (or the model of the smart glasses) can be created in an optical simulation software (e.g., Zemax). The model of the optical component can be acquired by the optical simulation software to obtain the imaging distortion of the optical component. An array of rectangular grids is then input into the image plane of the optical component. Optical tracking is performed when the sample pattern of the rectangular grids is displayed on the image plane of the optical component, so as to obtain the array of distorted grids on the object plane of the optical component. The array of rectangular grids may have the shape of the image 11 as shown in FIG. 1.

When the display panel displays the obtained array of distorted grids, the user can see the array of rectangular grids via the optical component. That is, when the display panel displays the image 21 in which a pillow distortion occurs as shown in FIG. 2, the user can see an image 11 of normal grids as shown in FIG. 1 via the optical component.

It should be noted that the display device in this exemplary embodiment may be any product or component having a display function, such as an electronic paper, a mobile phone, a tablet computer, a television, a notebook computer, a digital photo frame, a navigator, and the like. The contour shape of the display device may be the same as or different from the contour shape of the display panel. For example, when the contour shape of the display panel is a pillow contour shape, the contour shape of the display device may be a pillow contour shape or a rectangular contour shape.

The processes used in the above steps may include, for example, a film forming process (e.g. deposition and sputtering) and a composition process (e.g. etching).

The above exemplary embodiments are only used for explanations rather than limitations to the present disclosure, the ordinary skilled person in the related technical field, in the case of not departing from the spirit and scope of the present disclosure, may also make various modifications and variations, therefore, all the equivalent solutions also belong to the scope of the present disclosure, the patent protection scope of the present disclosure should be defined by the claims.

What is claimed is:

1. A display panel, comprising:
a substrate; and
a pixel array disposed on the substrate;
wherein a contour shape of the pixel array is same to a contour shape of the display panel; the contour shape of the display panel is one of a pillow contour shape and a barrel contour shape; the pillow contour shape is recessed from a periphery toward a center, and the barrel contour shape is convex from a center to a periphery;
wherein distortion of a pixel in the pixel array increases as a distance between the pixel and a central axis of the pixel array increases; and
wherein for the pillow contour shape, an area of the pixel in the pixel array increases as the distance between the pixel and the central axis of the pixel array increases; for the barrel contour shape, an area of the pixel in the pixel array decreases as the distance between the pixel and the central axis of the pixel array increases.

2. The display panel according to claim 1, wherein the pixel array is composed of N pixel blocks; N is a natural number greater than 1; pixel numbers of the N pixel blocks are equal; the contour shape of the pixel array is formed by a contour shape of the N pixel blocks; a contour shape of each pixel block is substantially same to a contour shape of a pixel in the pixel block;
wherein distortion of a pixel block increases as a distance between the pixel block and the central axis of the pixel array increases;
and wherein for the pillow contour shape, an area of the pixel block increases as the distance between the pixel block and the central axis of the pixel array increases; for the barrel contour shape, an area of the pixel block decreases as the distance between the pixel block and the central axis of the pixel array increases.

3. The display panel according to claim 1, wherein pixels in the pixel array are non-uniformly distributed.

4. The display panel according to claim 3, wherein for the pillow contour shape, a density of the pixels in the pixel array gradually decreases in a direction away from the central axis; for the barrel shape, a density of the pixels in the pixel array gradually increases in a direction away from the central axis.

5. A display device comprising the display panel according to claim 1 and an optical component; wherein the display panel is located on an object plane of the optical component, and the optical component has an imaging distortion complementary to the contour shape of the display panel.

6. The display device according to claim 5, wherein the pixel array is composed of N pixel blocks; N is a natural number greater than 1; pixel numbers of the N pixel blocks are equal; the contour shape of the pixel array is formed by a contour shape of the N pixel blocks; a contour shape of each pixel block is substantially same to a contour shape of a pixel in the pixel block;
wherein distortion of a pixel block increases as a distance between the pixel block and the central axis of the pixel array increases;
and wherein for the pillow contour shape, an area of the pixel block increases as the distance between the pixel block and the central axis of the pixel array increases; for the barrel contour shape, an area of the pixel block decreases as the distance between the pixel block and the central axis of the pixel array increases.

7. The display device according to claim 5, wherein pixels in the pixel array are non-uniformly distributed.

8. The display device according to claim 7, wherein for the pillow contour shape, a density of the pixels in the pixel array gradually decreases in a direction away from the central axis; for the barrel shape, a density of the pixels in the pixel array gradually increases in a direction away from the central axis.

9. A pair of smart glasses comprising the display panel according to claim 1 and an optical component; wherein the display panel is located on an object plane of the optical component, and the optical component has an imaging distortion complementary to the contour shape of the display panel.

10. The pair of smart glasses according to claim 9, wherein the pixel array is composed of N pixel blocks; N is a natural number greater than 1; pixel numbers of the N pixel blocks are equal; the contour shape of the pixel array is formed by a contour shape of the N pixel blocks; a contour shape of each pixel block is substantially same to a contour shape of a pixel in the pixel block;
wherein distortion of a pixel block increases as a distance between the pixel block and the central axis of the pixel array increases;
and wherein for the pillow contour shape, an area of the pixel block increases as the distance between the pixel block and the central axis of the pixel array increases; for the barrel contour shape, an area of the pixel block decreases as the distance between the pixel block and the central axis of the pixel array increases.

11. The pair of smart glasses according to claim 9, wherein pixels in the pixel array are non-uniformly distributed.

12. The pair of smart glasses according to claim 11, wherein for the pillow contour shape, a density of the pixels in the pixel array gradually decreases in a direction away from the central axis; for the barrel shape, a density of the pixels in the pixel array gradually increases in a direction away from the central axis.

13. A method for manufacturing a display panel, comprising:
providing a substrate; and
forming a pixel array on the substrate;
wherein a contour shape of the pixel array is same to a contour shape of the display panel; the contour shape of the display panel is one of a pillow contour shape and a barrel contour shape; the pillow contour shape is recessed from a periphery toward a center, and the barrel contour shape is convex from a center to a periphery;
wherein distortion of a pixel in the pixel array increases as a distance between the pixel and a central axis of the pixel array increases; and
wherein for the pillow contour shape, an area of the pixel in the pixel array increases as the distance between the pixel and the central axis of the pixel array increases; for the barrel contour shape, an area of the pixel in the pixel array decreases as the distance between the pixel and the central axis of the pixel array increases.

14. The method according to claim 13, wherein the pixel array is composed of N pixel blocks; N is a natural number greater than 1; pixel numbers of the N pixel blocks are equal; the contour shape of the pixel array is formed by a contour shape of the N pixel blocks; a contour shape of each pixel block is substantially same to a contour shape of a pixel in the pixel block;
wherein distortion of a pixel block increases as a distance between the pixel block and the central axis of the pixel array increases;
and wherein for the pillow contour shape, an area of the pixel block increases as the distance between the pixel block and the central axis of the pixel array increases; for the barrel contour shape, an area of the pixel block decreases as the distance between the pixel block and the central axis of the pixel array increases.

15. The method according to claim 13, wherein pixels in the pixel array are non-uniformly distributed.

16. The method according to claim 15, wherein for the pillow contour shape, a density of the pixels in the pixel array gradually decreases in a direction away from the central axis; for the barrel shape, a density of the pixels in the pixel array gradually increases in a direction away from the central axis.

17. The method according to claim 13, wherein forming the pixel array on the substrate comprises:
forming the pixel array based on an array of distorted grids;
wherein a contour shape of the array of distorted grids is same to the contour shape of the display panel; the contour shape of the display panel is one of a pillow contour shape and a barrel contour shape; the pillow contour shape is recessed from a periphery toward a center, and the barrel contour shape is convex from a center to a periphery;
wherein distortion of a distorted grid in the array of distorted grids increases as a distance between the distorted grid and a central axis of the array of distorted grids increases; and
wherein for the pillow contour shape, an area of the distorted grid in the array of distorted grids increases as the distance between the distorted grid and the central axis of the array of distorted grids increases; for the barrel contour shape, an area of the distorted grid in the array of distorted grids decreases as the distance between the distorted grid and the central axis of the array of distorted grids increases.

18. The method according to claim 17, wherein before forming the pixel array based on an array of distorted grids, the method further comprises:
performing a distortion process to an array of rectangular grids based on an optical parameter to obtain the array of distorted grids.

19. The method according to claim 18, wherein performing a distortion process to an array of rectangular grids based on an optical parameter to obtain the array of distorted grids comprises:
obtaining a model of an optical component having an imaging distortion;
inputting the array of rectangular grids into an image plane of the optical component; and
performing optical tracking to the array of rectangular grids to obtain the array of distorted grids on the object plane of the optical component.
